(19) United States
(12) Patent Application Publication
(10) Pub. No.: US 2005/0241495 A1
(43) Pub. Date: Nov. 3, 2005

(54) Baking oven having a linear pull-out element

(75) Inventors: Kerstin Feldmann, Traunreut (DE); Horst Fernsebner, Unterwossen (DE); Franz Götzendorfer, Traunstein (DE); Thomas Maier, Truchtlaching (DE); Peter Mallinger, Traunreut (DE); Dieter Mlotek, Traunwalchen (DE); Hans Rogenhofer, Holzkirchen (DE); Michael Schilcher, Traunreut (DE)

Correspondence Address: JOHN T. WINBURN, 100 BOSCH BOULEVARD, NEW BERN, NC, 28562, US

(73) Assignee: BSH Bosch und Siemens Haugerate, Munich (DE)

(21) Appl. No.: 10/525,997

(22) PCT Filed: Aug. 19, 2003
(86) PCT No.: PCT/EP03/09188

§ 371 Date: Feb. 28, 2005

(51) Int. Cl. A47J 9/00

(52) U.S. Cl. 99/448

(57) ABSTRACT

A baking oven including a holding part which is horizontally guided inside a baking chamber and can receive and hold a baking rack. The baking rack can be displaced between a baking position inside the baking chamber and a removed position at least partially in front of and outside of the baking chamber. The holding part includes a pair of retaining elements that are displaceably guided on opposite side walls of the cooking chamber, while being located at a distance from the upper and lower heating elements in the cooking chamber so as not to interfere with the heating elements.

The present invention relates to a baking oven comprising a holding part which is horizontally guided inside a baking chamber for receiving and holding a baking rack which can be displaced between a baking position inside the baking chamber and a removed position located, at least in part, in front thereof.

A generic baking oven comprising a holder part guided in a baking oven chamber which is attached to two horizontally displaceable carriages is known from DE 198 25 323 A1. The holder part is used to receive and hold cooked goods carriers which can be moved between a cooking position in the baking chamber and a removed position located at least in part outside the baking chamber. The carriages are arranged respectively in an upper area of the baking chamber, close to an upper heat source.

The object of the invention is to further improve a baking oven according to the preamble of claim 1 with regard to the stability and the compactness of the horizontal guidance.

According to the invention, this object is achieved according to the preamble of claim 1 by two retaining elements that are displaceably guided on opposing side walls of the baking chamber, which are respectively arranged at a distance from a top or from a bottom of the baking oven. As a result of the arrangement of the retaining element or its guides respectively at a distance from upper and lower heating elements of the baking chamber, the area available for the heating elements of the upper heat source and the lower heat source in the baking chamber is not impaired by guide elements arranged in their vicinity. Rather, approximately the total overall width of the baking chamber is available for the arrangement of the upper and lower heating elements. In addition, the approximately centrally arranged retaining element is subjected to a lower bending moment when a baking rack is suspended in an uppermost or a lowermost slide-in position.

In a preferred embodiment of the invention, each retaining element comprises at least one horizontally displaceable carriage for the horizontal guidance of a baking rack. Preferably, each of the two carriages is arranged in a central area on the side wall of the baking chamber. With the arrangement according to the invention, a very space-saving guidance of the removable baking rack can be achieved in a simple fashion. The guide elements furthermore have a very low mass and at the same time high stability.

One embodiment of the invention provides that the retaining element has a hooked rail which is displaceably guided and suspended on the carriage. The two hooked rails preferably each extend vertically so that their directions of longitudinal extension are each arranged perpendicular to the pull-out direction.

The length of the hooked rails is more appropriately somewhat less than the height of the baking chamber. In the pulled-out state of the guide rails one or a plurality of baking racks can be suspended in various positions of the hooked rails.

If necessary, the two hooked rails can be coupled to one another with a rigid cross bracing or cross connection so that one of the two hooked rails cannot be displaced backwards by mistake when suspending a baking rack and must be pulled manually forwards again. A locating position of the carriage can more appropriately be provided at least in the removed position. In this way, the baking rack can be suspended in the hooked rails without any problems and then pushed into the baking position by means of light pressure to overcome the catch. Such a locating position can advantageously additionally be provided in a baking position.

Roller bearings are especially suitable as mounting for the carriages. These roller bearings can either have grease lubrication or they can run dry if desired. Especially suitable for this purpose are roller bearings and/or ball tracks made of ceramic or having a ceramic coating. Such dry roller bearings are especially suitable for pyrolysis operation of the baking oven since in this case temperatures of up to 500° C. are achieved which would not be withstood by conventional grease lubrication of roller bearings.

A further preferred embodiment of the invention provides electrical insulation of the carriages and the hooked rails from the baking oven and from the baking chamber whereby this is microwave-suitable. By means of the electrical insulation a spark-gap or high-voltage breakdown to electrical parts in the baking chamber can be avoided. Electrical insulation can be achieved, for example, by the roller bearings consisting of an electrically insulating ceramic.

The invention is explained in detail subsequently using exemplary embodiments with reference to the drawings. In the figures:

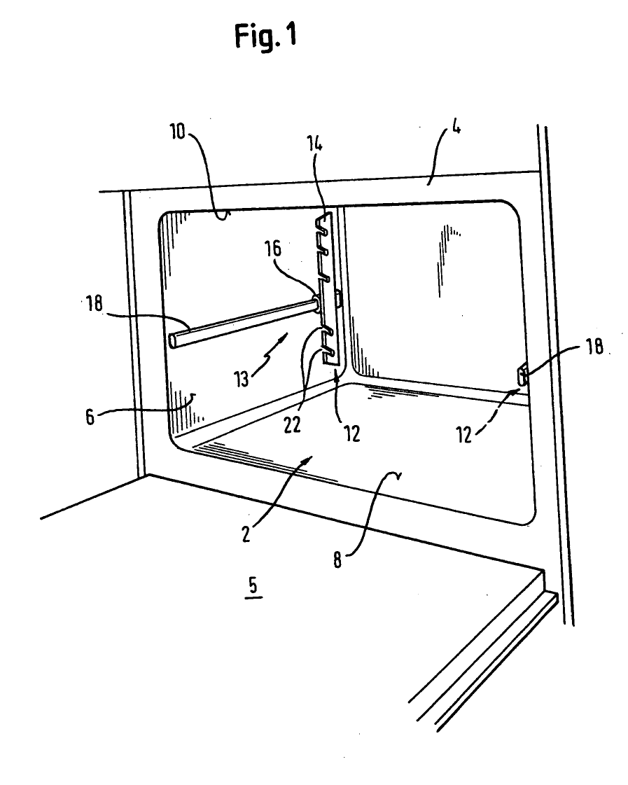

FIG. 1 is a schematic perspective view of a baking chamber with holding part located in the baking position,

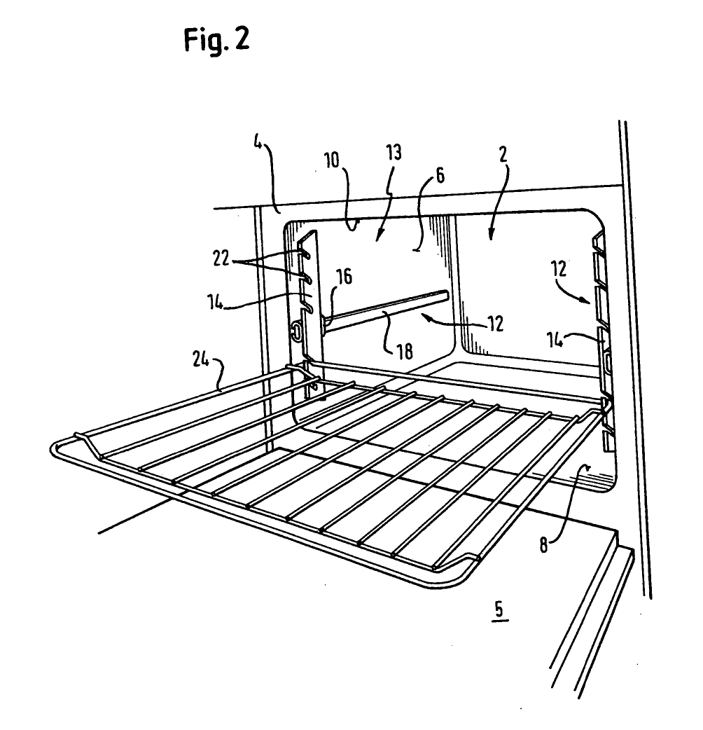

FIG. 2 is a perspective schematic view of the baking chamber with holding part located in the removed position and baking rack suspended therein,

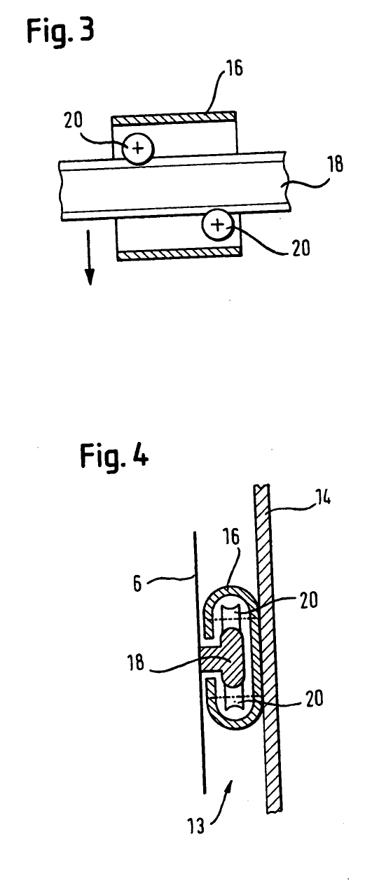

FIGS. 3 and 4 show a first variant of a carriage guide of the holding element in two views or sectional diagrams,

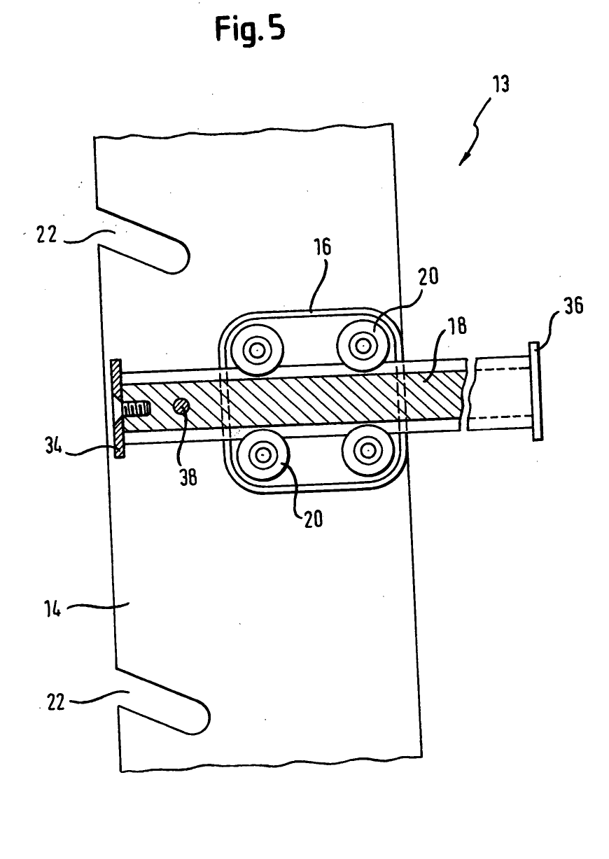

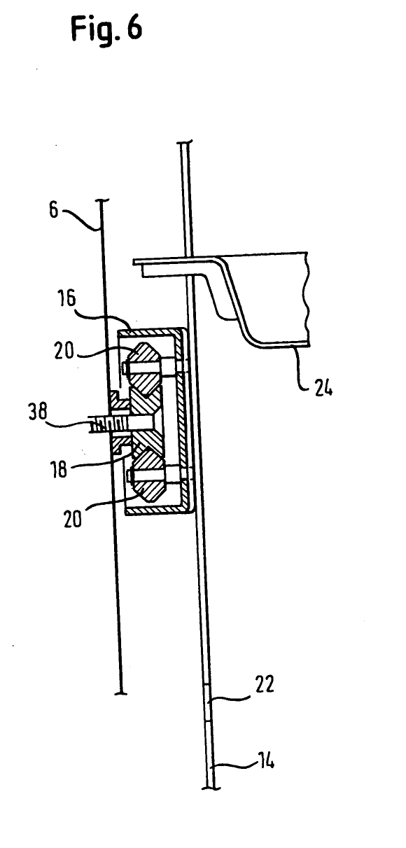

FIGS. 5 and 6 show a second variant of the carriage guide in two views or sectional diagrams,

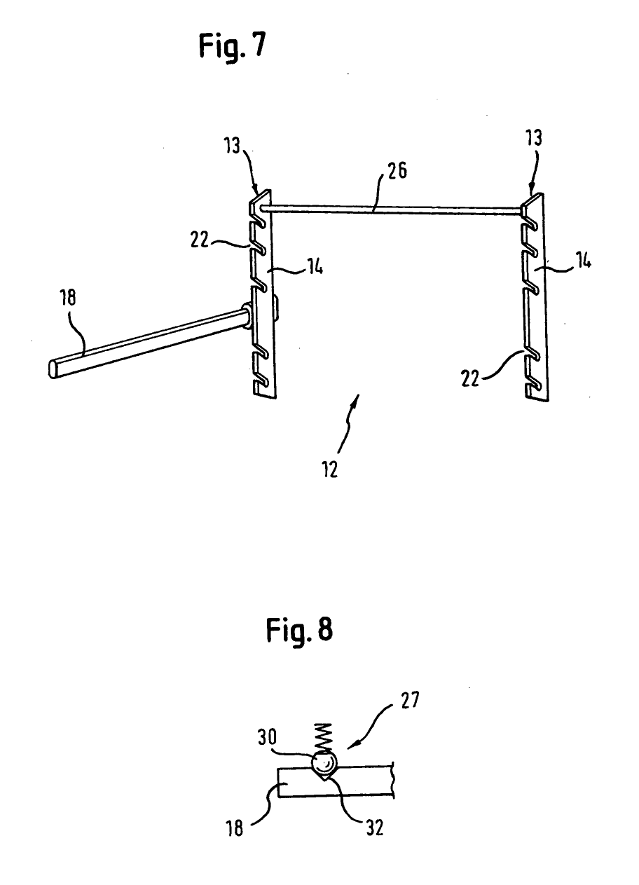

FIG. 7 show two hooked rails coupled together by means of cross bracing in perspective view and

FIG. 8 shows a schematic view of a device for locating the carriage in preferred positions.

FIG. 1 shows a perspective and schematic view of a baking chamber 2 of a baking oven. A baking oven door 5 which abuts against a front frame 4 in the closed position and which closes the baking chamber 2 on the front side is located in an opened position pivoted horizontally downwards. A holding part 12 according to the invention for supporting and guiding a baking rack comprises two retaining elements 13 which in the exemplary embodiment shown, have two hooked rails 14 which are each guided horizontally displaceably on side walls 6 of the baking chamber on a guide rail 18. For this purpose respectively one carriage 16 can slide along on each of the two guide rails 18 in the horizontal direction. A hooked rail 14 is rigidly affixed to each carriage 16. The hooked rails 14 consisting of narrow oblong sheet-metal strips have a direction of longitudinal extension perpendicular to the pull-out direction and parallel to the side walls 6. The hooked rails 14 preferably have a relatively short distance from a top 10 and from a bottom surface 8 of the baking chamber 2 so that the baking racks can be arranged as required close to or far from the upper or the lower heat.

The guide rails 18 more appropriately extend over approximately a same length which corresponds to a depth of the baking chamber 2. In this way, the carriages 16 can be displaced with the hooked rails 14 attached thereto approximately over the entire depth of the baking chamber 2. The guide rails 18 are each arranged in a central region of the side walls 6 so that there is no impairment of heating elements of an upper or lower heat by the guide rails 18 and the carriage 16 and the hooked rail 14 affixed thereto. In addition, it is clear that compared with a guide near the top 10 of the baking chamber 2 the maximum bending moment on the hooked rails 14 when suspending a baking rack in a lower slide-in position is significantly reduced. The holding part 12 can be significantly more compact for the same stability.

In the view in FIG. 1 the carriages 16 with the hooked rails 14 attached thereto are located in a baking position in the rearmost position, preferably at a rear stop of the carriage 16. A baking rack can be suspended in two grooves 22 of each hooked rail 14, located at the same height, so that they are located in a stable horizontal position. In the exemplary embodiment shown each hooked rail 14 has five grooves 22 separated from one another which each define an insertion height for a baking rack. In order to increase the stability of the hooked rails, these can possibly have an impression along their longitudinal direction of elongation which can ensure an increase in their bending strength and in this way can prevent contact with the side walls 6 even when a plurality of baking racks with correspondingly high loads are suspended.

FIG. 2 shows the hooked rails 14 in a front removed position in which both carriages 16 with the hooked rails 14 attached thereto are each located at a front stop near the front frame 4. In the view shown a baking rack 24 is suspended in a second position from below in the corresponding grooves 22.

A further development of the holding part 12 according to the invention can comprise a combination with telescopic pull-out elements. In this way, a so-called complete pull-out can be achieved in which the baking rack 24 can be pulled out into a position in front of the front frame 4. The exemplary embodiment shown with the rail pull-out element on the other hand only allows a partial pull-out in which a rear edge of the baking rack 24 is located in the removed position still inside the baking chamber 2.

Furthermore, it can be advantageous to mount the guide rails 18 and the carriages 16 sliding thereon in a corresponding arched indentation of the side wall 6 whereby the space requirement of the retaining element 12 is minimised. If necessary, a slightly narrower baking chamber can be sufficient to receive baking racks of unchanged width.

FIG. 3 shows a first variant of a guide of the carriage 16 on the guide rails 18. Respectively two roller elements 20 are rotatably mounted in each carriage 16. One roller element 20 slides on one top or on one upper edge of the guide rail 18. The other roller element 20 slides on a bottom or on a lower edge of the guide rail 18. As a result of the weight exerted by the baking rack, the arrangement shown in FIG. 3 with respectively one roller element 20 above and below the guide rail 18 is sufficient. The roller elements 20 are arranged offset with respect to one another in the carriage 16 so that by tilting the carriage 16 this can possibly be lifted from the guide rail 18 and removed.

The weight moment exerted by a baking rack which ensures stabilisation of the carriage 16 is indicated by the arrow. Alternatively, two roller elements can be provided respectively above and/or below, as shown in FIG. 5.

FIG. 4 shows a sectional view of a retaining element 13 of the holding part 12 viewed parallel to the pull-out direction of the carriage 16. The guide rail 18 is fixedly anchored in the side wall 6 and has a perpendicular guide section with respectively rounded upper and lower edges which at the same time form the running surfaces for the roller elements 20. In the exemplary embodiment shown the roller elements 20 respectively form a single-shell hyperboloid of rotation whose running surfaces embrace the running surfaces of the guide rail 18 on both sides. The hooked rail 14 is rigidly affixed on the side of the carriage 16 facing away from the side wall 6.

FIGS. 5 and 6 show, in two views or partial cross-sections, an alternative embodiment of the retaining element 12 according to the invention in which respectively four roller elements 20 are rotatably mounted in each carriage 16. Respectively two roller elements 20 at a distance from one another slide on the upper and on the lower edge of the guide rail 18. This has a front stop 34 and a rear stop 36 against which the carriage 16 can strike. The stops 34, 36 define the maximum path which can be covered by the carriage 16 on the guide rail 18. The guide rail 18 is anchored via a plurality of fixing points 38 on the side wall. FIG. 5 shows an offset mounting of the hooked rail 14 on the carriage 16 so that said carriage is moved closer to the front frame of the baking chamber in the removed position. Suspension and removal of the baking rack can thereby be facilitated if necessary.

As is clearly shown in FIG. 6, the carriage 16 has a shell-shaped contour with the roller element 20 suspended on one side. The hooked rail 14 is affixed on the closed side of the carriage 16 whereas the open side points towards the side wall 6 of the baking chamber. The carriage 16 largely embraces the guide rail 18 so that especially a very compact and space-saving unit is formed. In contrast to the first variant according to FIGS. 3 and 4, the roller elements in the second variant are formed as symmetrical double cones with respectively truncated front sides whose middle edge slides in a correspondingly groove-shaped roller track of the guide rail.

This alternative configuration of the carriage and the guide rail is distinguished by particular compactness. The holding part 12 with the two retaining elements 13 can be executed in this way as particularly narrow and space-saving so that the overall width of the baking chamber is barely enlarged compared with baking chambers provided with conventional slide-in units. If necessary, the guide rail positioned on the side walls 6 of the baking chamber 2 can also be recessed in a corresponding indentation so that substantially only the hooked rail projects at a short distance from the side wall 6 of the baking chamber from its lateral contour. In this way, a further reduction in the overall width of the baking chamber can be achieved.

Shown with reference to FIG. 6 is a baking rack 24 suspended in grooves 22, which is located in a middle insertion position approximately at the height of the guide rail 18.

FIG. 7 shows in perspective view a preferred embodiment of the holding part 12 in which the two hooked rails 14 are interconnected by a cross bracing 26. In this way, it can be avoided that one of the hooked rails 14 is pushed backwards by mistake during suspension of the baking rack.

FIG. 8 shows a possible embodiment of a locating device 27 which consists of a spring-loaded ball 30 which can belocated in an indentation 32 of the guide rail 18. The ball 30 is preferably held in the carriage and engages in an indentation 32 located in the front area of the guide rail 18 and thus defining a location in the removed position. If necessary, a further indentation can additionally be provided in a rear region of the guide rail 18 which defines a further location position in the baking position of the baking rack. The locating positions preferably correspond to the corresponding stops of the carriage (see FIG. 6) so that the maximum displacement path of the retaining element is used in practice.

If the baking oven is to be operated in a pyrolysis mode, the roller bearing shown cannot have conventional grease lubrication. In order to be able to withstand the high temperatures of around 500° C., roller pairs made of ceramic or having a ceramic coating are especially suitable. Such a roller pair also has the advantage that the holding part 12 can be electrically isolated from the baking chamber. This makes it possible for the baking oven to be microwave suitable since no spark-gap or high-voltage breakdown is to be feared as a result of the insulation of the retaining element.

Possible materials for the guide rails, the carriages and the hooked rails are, for example, aluminium, stainless steel or brass which can possibly have a ceramic coating on the guide rail.

### REFERENCE LIST

2 Baking chamber
4 Front frame
5 Baking oven door
6 Side wall
8 Bottom surface
10 Top
12 Holding part
13 Retaining element
14 Hooked rail
16 Carriage
18 Guide rail
20 Roller member
22 Groove
24 Baking rack
26 Cross bracing
27 Locating device
28 Spring
30 Ball
32 Indentation
   34 Front stop
36 Rear stop
38 Fixing point

1-7. (canceled)

8. A baking oven, comprising:
a baking chamber;
a baking rack insertable in said baking chamber;
a holding part, said holding part horizontally guided in said baking chamber;
said holding part receiving and holding said baking rack;
said holding part and said baking rack displaceable between a baking position with said baking rack inside said baking chamber and a removed position with said baking rack located, at least in part, outside and in front of said baking chamber; and
said holding part including two retaining elements arranged on opposite side walls of said baking chamber and at a distance from at least one of the top wall and the bottom wall of said baking chamber.

9. The baking oven according to claim 8, including each of said two retaining elements is guided by a displaceable carriage.

10. The baking oven according to claim 9, including each said displaceable carriage is arranged one of said opposite side walls of said baking chamber in a middle height region of said baking chamber.

11. The baking oven according to claim 9, including each of said two retaining elements including a hooked rail which is affixed to one of said displaceable carriages.

12. The baking oven according to claim 11, including said hooked rails are coupled to one another by a cross bracing.

13. The baking oven according to claim 9, including each of said displaceable carriages includes a locating position at least in said removed position.

14. The baking oven according to claim 9, including each of said displaceable carriages is roller-mounted on a guide rail.

15. The baking oven according to claim 14, including a forward and a rear stop position on at least one of said guide rails for at least one of said displaceable carriages.

16. A baking oven, comprising:
a baking chamber;
a baking rack insertable in said baking chamber;
a holding part, said holding part horizontally guided in said baking chamber;
said holding-part receiving and holding said baking rack;
said holding part and said baking rack displaceable between a baking position with said baking rack inside said baking chamber and a removed position with said baking rack located, at least in part, outside and in front of said baking chamber;
said holding part including two retaining elements arranged on opposite side walls of said baking chamber and at a distance from at least one of the top wall and the bottom wall of said baking chamber; and
each of said two retaining elements is guided by a displaceable carriage mounted on a guide rail, said guide rails affixed to said opposite side walls of said baking chamber.

17. The baking oven according to claim 16, including each of said guide rails is affixed and each said displaceable carriage is arranged one of said opposite side walls of said baking chamber in a middle height region of said baking chamber.

18. The baking oven according to claim 16, including each of said two retaining elements including a hooked rail which is affixed to one of said displaceable carriages, said hooked rail having a plurality of grooves for suspending a baking rack at a desired location from a pair of said grooves, one in each of said hooked rails.

19. The baking oven according to claim 18, including said hooked rails are fixedly connected to one another by a cross bracing.

20. The baking oven according to claim 16, including at least one of said displaceable carriages having a locating position at least in said removed position.

21. The baking oven according to claim 16, including each of said displaceable carriages is roller-mounted on one of said guide rails.

22. The baking oven according to claim 21, including each of said displaceable carriages is roller-mounted on one of said guide rails by at least one roller element above and below of said guide rail.

23. The baking oven according to claim 22, including each of said displaceable carriages is roller-mounted on one of said guide rails by at least one roller element above and below of said guide rail and said roller element above said guide rail is offset laterally from said roller element below said guide rail.

24. The baking oven according to claim 22, including each of said displaceable carriages is roller-mounted on one of said guide rails by at least a pair of roller elements above and a pair of roller elements below said guide rail.

25. The baking oven according to claim 22, including a forward and a rear stop position on at least one of said guide rails for at least one of said displaceable carriages.

26. The baking oven according to claim 16, including a forward and a rear stop position on at least one of said guide rails for at least one of said displaceable carriages.
